(19) United States
(12) Patent Application Publication
(10) Pub. No.: US 2012/0139530 A1
(43) Pub. Date: Jun. 7, 2012

(54) ELECTROMAGNETIC ARRAY FOR SUBTERRANEAN MAGNETIC RANGING OPERATIONS

(75) Inventors: Graham A. McElhinney, Aberdeenshire (GB); Robert A. Moore, Katy, TX (US)

(73) Assignee: SMITH INTERNATIONAL, INC., Houston, TX (US)

(21) Appl. No.: 12/962,109

(22) Filed: Dec. 7, 2010

(51) Int. Cl. G01B 7/14

(52) U.S. Cl. 324/207.13

(57) ABSTRACT

An electromagnetic array includes a plurality of axially spaced electromagnets deployed in a non-magnetic housing. The array further includes an electrical module, such as a diode bridge, configured to provide an electrical current having a fixed polarity to at least the first electromagnet in the array. The array may be configured to generate a magnetic field pattern having (i) a single magnetic dipole when the array is energized with an electrical current having a first polarity and (ii) at least one pair of opposing magnetic poles when the array is energized with an electrical current having the opposite polarity. The invention provides multiple independent ranging methodologies for determining the relative position between the wellbores.

### RELATED APPLICATIONS

None.

### FIELD OF THE INVENTION

The present invention relates generally to drilling and surveying subterranean boreholes such as for use in oil and natural gas exploration. In particular, this invention relates to an apparatus and method for making magnetic ranging measurements of a subterranean borehole.

### BACKGROUND OF THE INVENTION

Active magnetic ranging techniques are commonly utilized in well twinning, well intercept, and well guidance applications, for example, including steam assisted gravity drainage (SAGD) and coal-bed methane (CBM) drilling applications. CBM well intercept applications commonly include an operation in which a vertical, or near vertical, borehole is intercepted with a deviated borehole (e.g., a horizontal or near horizontal borehole). Such applications commonly make use of a magnetic source deployed in the vertical (target) well and a magnetic field sensor deployed in the horizontal (drilling) well.

The use of electromagnets (as the magnetic source) in downhole ranging operations has been known for many years. For example, U.S. Pat. No. 3,406,766 to Henderson (issued in 1968) discloses a well intercept operation in which a magnetic field is established using a downhole electromagnet. Directional drilling is then guided based on measurements of the magnetic field. U.S. Pat. Nos. 3,731,752 to Schad; 4,646,277 to Bridges et al; and 4,812,812 to Flowerdew et al disclose similar arrangements in which a magnetic field induced by a downhole electromagnet is utilized to guide the direction of drilling of a subterranean borehole. U.S. Pat. No. 5,485,089 to Kuckes discloses a well twinning operation in which a high strength electromagnet is pulled down through a cased target well during drilling of a twin well. A magnetic field sensor deployed in the drill string measures the magnitude and direction of the magnetic field during drilling of the twin well to determine a distance and direction to the target.

While electromagnets have been utilized in commercial magnetic ranging operations, e.g., the aforementioned CBM and SAGD operations, there remains room for improvement. For example, difficulties remain in computing an accurate relative position of the drilling well with respect to the target well (i.e., between the magnetic field sensor in the drilling well and the electromagnetic source in the target well). There remains a need for an improved electromagnetic array for active ranging operations. There also remains a need for improved ranging methods, and in particular, improved methods for determining the relative position of a drilling well with respect to a target well.

### SUMMARY OF THE INVENTION

Exemplary aspects of the present invention are intended to address the above described drawbacks of prior art ranging methods. One aspect of this invention includes an electromagnetic array configured for use in subterranean ranging operations. The array includes a plurality of axially spaced electromagnets deployed substantially coaxially with one another in a non-magnetic housing. The array further includes an electrical module, such as a diode bridge, configured to provide an electrical current having a fixed polarity to at least the first electromagnet in the array. Advantageous embodiments of the electromagnetic array are configured to generate a magnetic field pattern having (i) a single magnetic dipole when the array is energized with an electrical current having a first polarity and (ii) at least one pair of opposing magnetic poles when the array is energized with an electrical current having the opposite polarity.

Exemplary embodiments of the present invention provide several potential advantages. In particular, the invention tends to improve the accuracy of subterranean magnetic ranging operations. Such improved accuracy tends to result in improved well placement in various intercept and twinning operations. The invention further provides multiple independent ranging methodologies for determining the relative position between the wellbores. These multiple methods tend to provide redundancy and increased operational flexibility in a wide variety of ranging operations. These and other advantages of the invention are discussed in more detail below.

In one aspect the present invention includes an electromagnetic array configured for use in a subterranean borehole. The array includes a substantially cylindrical non-magnetic housing configured to be deployed in a subterranean borehole. At least first and second coaxial electromagnets are axial spaced apart in the housing. An electrical module is configured to provide an electrical current having a fixed polarity to at least the first electromagnet. In one preferred embodiment the array is configured to generate a first magnetic field pattern when energized with an electrical current having a first polarity and a distinct second magnetic field pattern when energized with an electrical current having a second opposite polarity, the first magnetic field pattern including a single magnetic dipole and the second magnetic field pattern including at least one pair of opposing magnetic poles.

In another aspect, the present invention includes a method for surveying a borehole with respect to a target well. An electromagnetic array is deployed in the target well. The array includes a plurality of axially spaced apart electromagnets and is configured to generate a magnetic field having (i) a first pattern when energized with an electrical current having a first polarity and (ii) a second pattern when energized with an electrical current having a second opposite polarity. The array is energized with electrical currents having the first and second polarities so as to generate magnetic fields having the first and second patterns about the target well. Corresponding first and second magnetic field vectors are measured using the magnetic field sensor. The first and second magnetic field vectors are then processed to acquire at least a distance between the magnetic field sensor and the electromagnetic array.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiments disclosed may be readily utilized as a basis for modifying or designing other structures for carrying out the same purposes of the present invention. It should also be realize by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 depicts one example of an electromagnetic array deployed in a subterranean borehole.

FIG. 2A depicts the electromagnetic array shown on FIG. 1.

FIG. 2B depicts an alternative electromagnetic array including first, second, and third electromagnets.

FIG. 3A depicts one exemplary embodiment of the electromagnetic array depicted on FIG. 2B.

FIGS. 3B and 3C depict the magnetic polarities of electromagnets 310A-C in FIG. 3A for a positive applied electric current (FIG. 3B) and a negative applied electric current (FIG. 3C).

FIG. 4 depicts a flow chart of one exemplary method embodiment in accordance with the present invention.

FIGS. 5A and 5B depict contour plots of the theoretical magnetic flux density about a borehole when the electromagnetic array in FIG. 3 is polarized with a first polarity (FIG. 5A) and a second polarity (FIG. 5B).

FIG. 6 depicts a flow chart of another exemplary method embodiment in accordance with the present invention.

### DETAILED DESCRIPTION

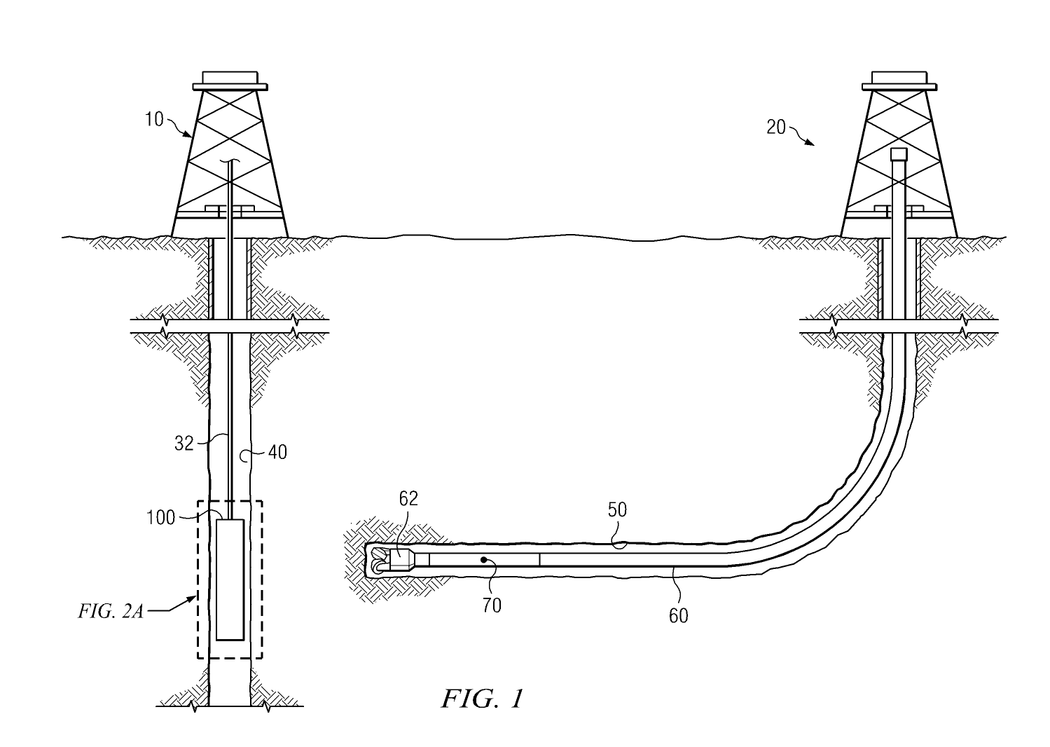

Referring now to FIGS. 1 through 6, exemplary embodiments of the present invention are depicted. With respect to FIGS. 1 through 6, it will be understood that features or aspects of the embodiments illustrated may be shown from various views. Where such features or aspects are common to particular views, they are labeled using the same reference numeral. Thus, a feature or aspect labeled with a particular reference numeral on one view in FIGS. 1 through 6 may be described herein with respect to that reference numeral shown on other views.

FIG. 1 depicts one exemplary embodiment of a horizontal to vertical well intercept operation in accordance with the present invention. In FIG. 1, first and second rigs 10 and 20 are positioned over a subterranean oil or gas formation (e.g., a coal bed—not shown). The rigs may include, for example, conventional derricks and hoisting apparatuses for lowering and raising various components into and out of corresponding wellbores 40 and 50. In the exemplary embodiment depicted substantially horizontal wellbore 50 is shown being drilled towards substantially vertical wellbore 40 so as to intercept (or nearly intercept) the vertical wellbore 40. It will be understood that the invention is not limited by the wellbore geometry depicted on FIG. 1. Nor is the invention even limited to well intercept operations.

As depicted on FIG. 1, an electromagnetic array 100 in accordance with the present invention is deployed in wellbore 40. Array 100 is depicted as being physically and electrically connected to the surface by a conventional wireline 32 and may be lowered down into wellbore 40, for example, using conventional wireline and/or slick line techniques known to those of ordinary skill in the art. However, the invention is not limited in these regards. A conventional drill string 60, including drill bit 62, is deployed in wellbore 50. Drill string 60 further includes a magnetic measurement tool (e.g., a conventional measurement while drilling tool) having at least one magnetic field sensor 70 deployed thereon (and within sensory range of magnetic flux generated by array 100). As will be understood by those of ordinary skill in the art, the magnetic field sensor is configured to (and intended to) measure magnetic flux generated by the electromagnetic array 100. Such measurements may then be utilized to compute a relative position (e.g., a distance and direction) between the two wells 40 and 50 and to guide drilling of wellbore 40 towards wellbore 50. A tri-axial magnetic field sensor is preferred as is described in more detail below as such a sensor enables the measurement of a three-dimensional magnetic field vector.

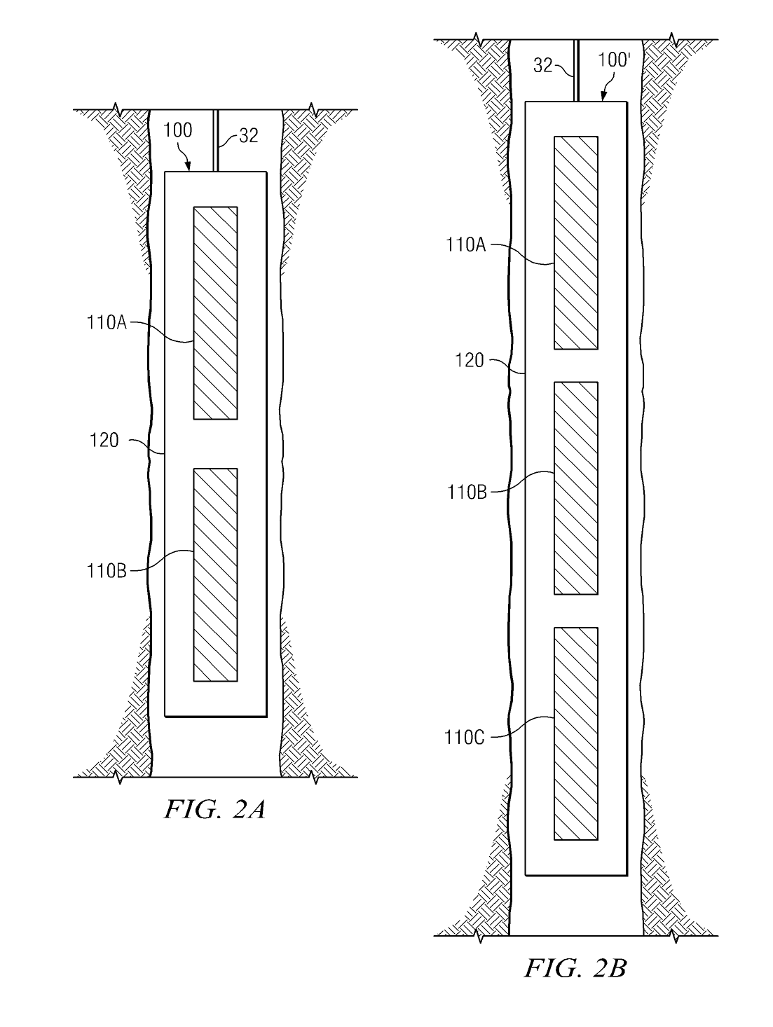

Turning now to FIG. 2A, the exemplary electromagnetic array embodiment 100 depicted includes first and second electromagnets 110A and 110B deployed in a non magnetic housing 120. The housing 120 may optionally include (or be fitted with) one or more centralizers (not shown), such as conventional stabilizer fins configured to substantially center the housing 120 in wellbore 40. The invention is not limited to any particular centralizing configuration or even to the use of a centralizer. The electromagnets 110A and 110B may be advantageously axially spaced apart from one another and deployed substantially coaxially with one another in the housing 120 (e.g., as depicted).

Substantially any suitable electromagnets may be utilized. High strength electromagnets are preferred and generally include a coil having a large number of turns of an insulated electrical conductor wound about a ferromagnetic core. Preferred high strength electromagnets are generally configured to be capable of generating a large magnetic flux (e.g., on the order of 1 Weber or greater). In one exemplary embodiment each of the electromagnets includes a substantially cylindrical soft iron core having a length of several feet (e.g., 4, 8, or 16 feet). The core is preferably wound with several thousand wraps of electrical conductor (e.g., 2000, 4000, 8000, or even 16,000 wraps). The conductor is preferably of a sufficient diameter to enable the use of large electrical currents (e.g., 1 Amp or greater) without a significant voltage loss and temperature increase.

FIG. 2B, depicts an alternative electromagnetic array embodiment 100′ in accordance with the present invention including first, second, and third electromagnets 110A, 110B, and 110C deployed in a non magnetic housing 120. Electromagnets 100 and 100′ are configured in accordance with the present invention to produce (i) a single magnetic dipole when the array is energized with an electrical current having a first polarity (e.g., a positive polarity) and (ii) at least one pair of opposing magnetic poles when the array is energized with an electrical current having a second opposite polarity (e.g., a negative polarity).

One aspect of the present invention is the insight that it can be advantageous to vary or change the magnetic pattern generated by the electromagnetic array during a drilling operation (e.g., between successive ranging measurements). Certain of these advantages are described in more detail below. In well intercept applications (particularly horizontal to vertical intercepts as depicted on FIG. 1) a change from a dipole magnetic pattern having no opposing magnetic poles (a magnetic dipole) to a magnetic pattern including at least one pair of opposing magnetic poles has been found to be most advantageous. A dipole pattern tends to provide maximum sensitivity at long range (long distances between the drilling well and the target well) while the pattern having at least one pair of opposing magnetic poles tends to provide a more accurate determination of the relative direction between the two wells. Moreover, a pattern including at least one pair of opposing magnetic poles tends to facilitate guiding the drilling well towards a particular axial position on the target well (e.g., directly towards the pair of opposing magnetic poles).

Such a change in the magnetic pattern may be readily accomplished, for example, by separately wiring each of the electromagnets in the array and changing the polarity (current direction) to various electromagnets as required. While such an arrangement is feasible, it would require running multi-core cabling from the surface to the electromagnetic array. Such multi-core cabling tends to be considerably thicker and more expensive than mono-core cabling. Its use is therefore not preferred.

While FIGS. 2A and 2B depict array embodiments including two and three electromagnets, it will be understood that the invention is not limited to the use of any particular number of electromagnets. For certain applications (e.g., applications in which a long ranging distance is required), additional electromagnets may be advantageously utilized to lengthen the array. The modular nature of the inventive array tends to enable additional electromagnets to be easily added.

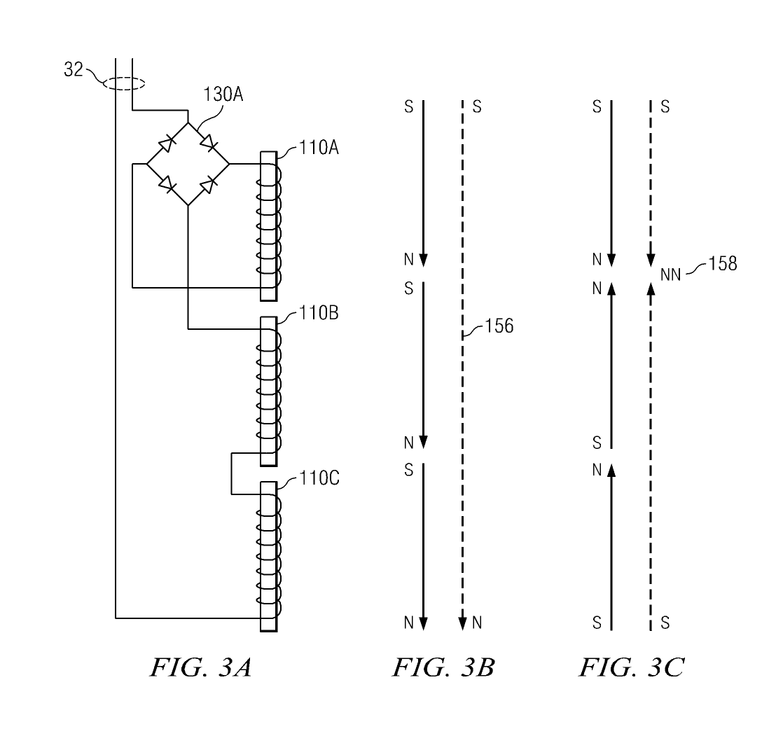

FIG. 3A depicts one exemplary arrangement of electromagnetic array 100′. In the exemplary embodiment depicted, electromagnet 110A is connected to electrical power through diode bridge 130A. As known to those of ordinary skill in the electrical arts, a diode bridge is an arrangement of diodes in a configuration that causes the polarity of the output to be independent of the polarity of the input. In the exemplary embodiment depicted diode bridge 130A is configured such that electromagnet 110A generates a magnetic field in a first direction (e.g., downward as depicted on FIGS. 3B and 3C) irrespective of the source polarity (i.e., changing the polarity of the applied electrical current has no effect on the direction of the magnetic field). Those of ordinary skill in the electrical arts will readily appreciate that the invention is not limited to the particular diode bridge configuration depicted on FIG. 3A. The invention may include substantially any suitable electrical module that provides an output having a fixed polarity irrespective of the input polarity.

In the exemplary embodiment depicted electromagnets 110B and 110C are connected directly to electrical power as depicted such that they are polarized in the same direction (i.e., both down or both up). When electrical power having a first polarity is applied to the array, a magnetic field having a dipole pattern (no pairs of opposing poles) is generated as depicted at 156 on FIG. 3B. When the polarity of the applied electrical current is reversed, the magnetic field generated by electromagnets 110B and 110C likewise reverses resulting in a magnetic field pattern having a single pair of opposing magnetic poles 158 (NN in the exemplary embodiment depicted) located between electromagnets 110A and 110B as depicted on FIG. 3C.

Those of ordinary skill in the art will appreciate that the electromagnets in FIG. 3A are depicted as being connected in series. Such a series connection may be advantageous in certain applications in that it ensures that the product of the electrical current and the number of turns (wraps) is identical for each electromagnet in the array. This ensures that the electromagnets generate substantially equal magnetic flux. It will be understood that the invention is not limited in this regard as the electromagnets may also be connected in parallel and that the depicted bridge diodes may also be employed on any of the individual electromagnets, as desired.

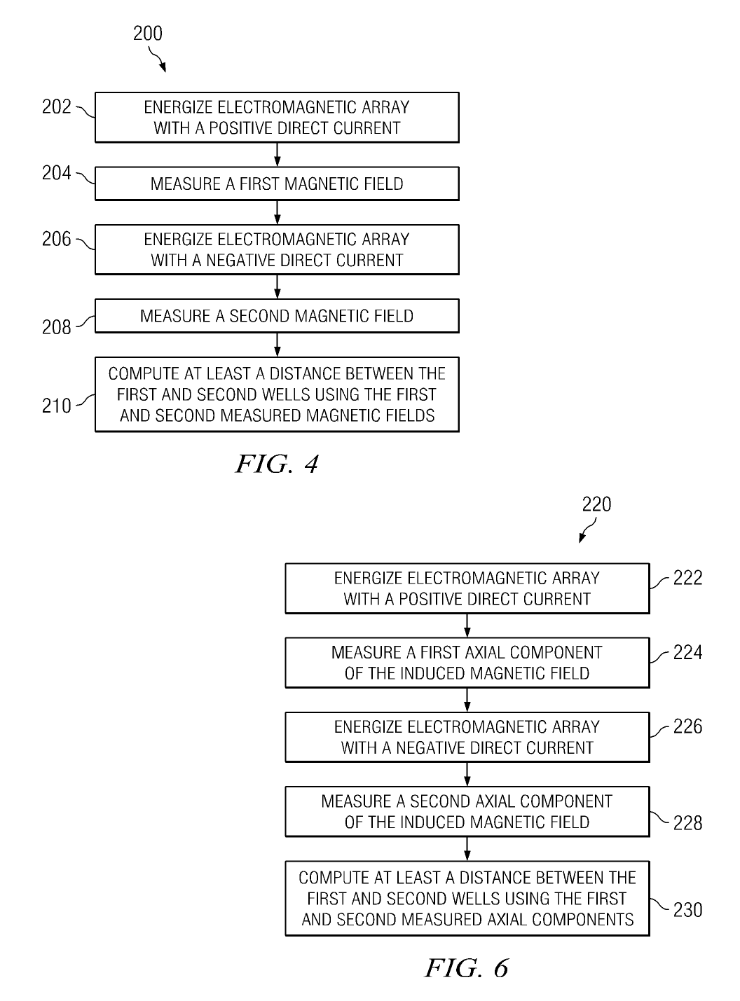

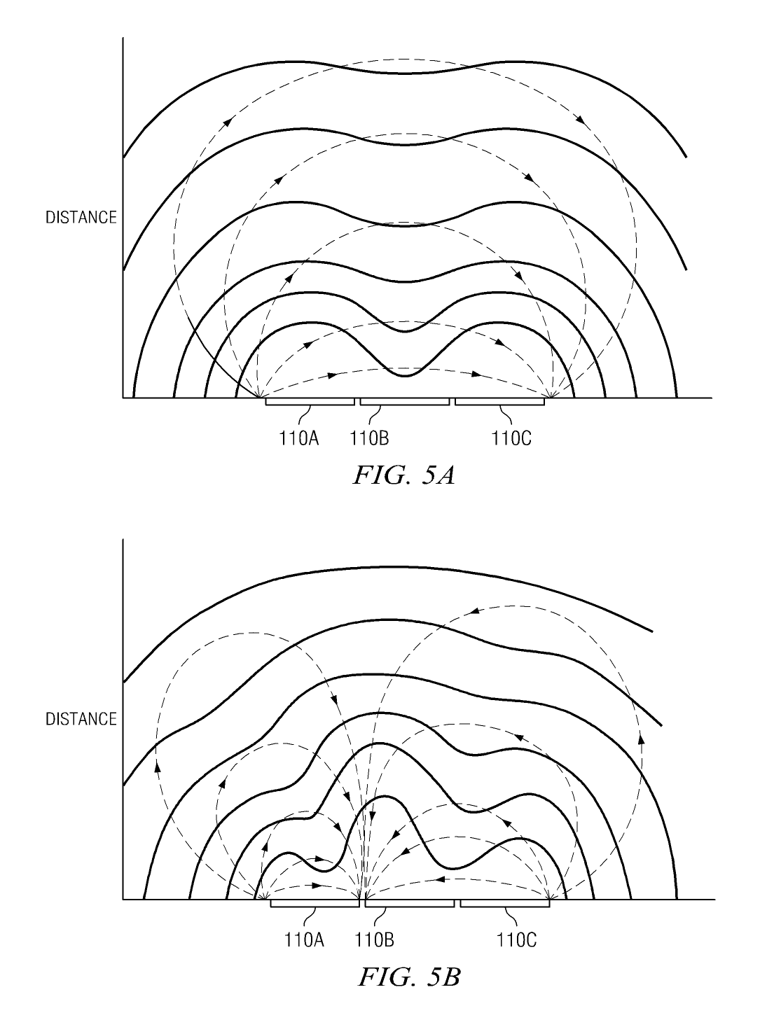

FIGS. 1 and 4 show one exemplary embodiment of a method by which the electromagnetic array of the present invention may be advantageously utilized in a subterranean magnetic ranging operation. FIG. 4 depicts a flow chart of one such exemplary magnetic ranging embodiment 200 in accordance with the present invention. The electromagnetic array (e.g., array 100 or 100′) is deployed in a first subterranean borehole and is energized with a positive direct current at 202. Energizing the array generates a magnetic field having a first pattern into the subterranean formation (e.g., as depicted on FIG. 5A which is described in more detail below). A magnetic field sensor deployed in a second subterranean borehole is utilized to measure a first magnetic field vector at 204. The magnetic field sensor may be deployed, for example, in a drill string which is in turn deployed in the second borehole (e.g., as depicted on FIG. 1). The electromagnetic array is then energized with a negative direct current at 206. Energizing the array with a negative current generates a magnetic field having a distinct second pattern into the subterranean formation (e.g., as depicted on FIG. 5B). The magnetic field sensor is then utilized to measure a second magnetic field vector at 208. The first and second magnetic field factors (measured in 204 and 208) are processed at 210 to compute a relative position of the sensor with respect to the array (which is related to the distance and/or the direction between the first and second subterranean boreholes). While not depicted in the flow chart, this process may advantageously be repeated any number of times during the drilling operation of the second borehole.

It will be understood that the electromagnetic array is typically energized from the surface (since many watts of electrical power are commonly required to generate a magnetic field of sufficient strength). As described above, the array is preferably physically and electrically connected to the surface via conventional wireline or slick-line mono-core cabling. It will be further understood that the polarity of the direct electrical current is preferably (although not necessarily) set at the surface. This may be accomplished using conventional manual or automatic switching mechanisms known to those of ordinary skill in the art. Changes in electrical polarity may also be accomplished via the use of an alternating current (AC), for example, low frequency sinusoidal or square wave AC. The invention is not limited to any particular wiring arrangement or any particular means for controlling the polarity.

The first and second magnetic field vectors measured at 204 and 208 are preferably three-dimensional vectors measured using a tri-axial magnetic field sensor (e.g., a tri-axial magnetometer). In such embodiments, the sensor includes three mutually orthogonal magnetic field sensors, one of which is preferably oriented substantially parallel with the borehole axis. Such sensor arrangements are conventional in the art and are commonly used in subterranean surveying and magnetic ranging operations. A three dimensional magnetic field vector may be thought of as including x, y, and z components (referred to herein as M_{X}, M_{Y}, and M_{Z}). By convention in the art, the z component is commonly defined to be parallel with the borehole axis of the measuring well (the second borehole described above with respect to FIG. 4). As described in more detail below, exemplary method embodiments of this invention may only require magnetic field measurements along the longitudinal axis of the drill string (M_{Z}).

The magnetic field about the energized electromagnetic array may be measured and represented, for example, as a vector whose magnitude and orientation depends on the location of the measurement point within the magnetic field. In order to determine the magnetic field vector due to the array at any point downhole, the magnetic field of the earth is typically subtracted from the measured magnetic field vector, although the invention is not limited in this regard. The magnetic field of the earth (including both magnitude and direction components) is typically known, for example, from previous geological survey data or a geomagnetic model. However, for some applications it may be advantageous to measure the magnetic field in real time on site at a location substantially free from magnetic interference, e.g., at the surface of the well or in a previously drilled well. Measurement of the magnetic field in real time is generally advantageous in that it accounts for time dependent variations in the earth's magnetic field, e.g., as caused by solar winds. However, at certain sites, such as an offshore drilling rig, measurement of the earth's magnetic field in real time may not be practical. In such instances, it may be preferable to utilize previous geological survey data in combination with suitable interpolation and/or mathematical modeling (i.e., computer modeling) routines.

The earth's magnetic field at the downhole sensor and in the coordinate system of the downhole tool including the sensor may be expressed, for example, as follows:

M_{EX}=H_{E}(cos D sin Az cos R+cos D cos Az cos Inc sin R−sin D sin Inc sin R)

M_{EY}=H_{E}(cos D cos Az cos Inc cos R+sin D sin Inc cos R−cos D sin Az sin R)

M_{EZ}=H_{E}(sin D cos Inc−cos D cos Az sin Inc) Equation 1

where M_{EX}, M_{EY}, and M_{EZ} represent the x, y, and z components, respectively, of the earth's magnetic field as measured at the downhole tool, where the z component is aligned with the borehole axis, H_{E} is known (or measured as described above) and represents the magnitude of the earth's magnetic field, and D, which is also known (or measured), represents the local magnetic dip. Inc, Az, and R represent the Inclination, Azimuth (relative to magnetic north) and Rotation (also known as the gravity tool face), respectively, of the magnetic measurement tool, which may be obtained, for example, from conventional surveying techniques.

The magnetic field vectors due to the electromagnetic array (which are referred to herein as interference vectors) may then be represented as follows:

M_{TX}=M_{X}−M_{EX}

M_{TY}=M_{Y}−M_{EY}

M_{TZ}=M_{Z}−M_{EZ} Equation 2

where M_{TX}, M_{TY}, and M_{TZ} represent the x, y, and z components, respectively, of the interference magnetic field vector due to the electromagnetic array in the target well and Mₓ, My, and M_{z}, as described above, represent the measured magnetic field vectors in the x, y, and z directions, respectively.

The artisan of ordinary skill will readily recognize that in determining the interference magnetic field vectors it may also be necessary to subtract other magnetic field components from the measured magnetic field vectors. For example, such other magnetic field components may be the result of drill string, drill bit, steering tool, and/or drilling motor interference. Techniques for accounting for such interference are well known in the art. Moreover, magnetic interference may emanate from other nearby cased boreholes.

The relative position (e.g., a distance and/or a direction) between the first and second wellbores may be advantageously computed, for example, using magnetic models of the induced magnetic field about the positively and negatively energized electromagnetic array (i.e., about the first wellbore when the deployed array is energized). The magnetic field about an open borehole in which an electromagnetic array is deployed and energized may be modeled, for example, using conventional finite element techniques. FIG. 5A depicts a contour plot of the flux density and magnetic flux lines about an open borehole having an electromagnetic array similar to that depicted on FIG. 2B deployed therein and energized with an electrical current having a positive polarity. The solid lines depict flux density while the dotted lines depict the magnetic flux lines. FIG. 5B depicts flux density (solid lines) and flux lines (dotted lines) for the same electromagnetic array when energized with an electrical current having a negative polarity. Each of the three electromagnets in the modeled array is 8 feet in length and includes 5000 wraps of electrical conductor about a two-inch diameter silicon iron (SiFe) core. The electromagnetic array is deployed in an open borehole (non-cased) and energized with a DC current of e.g. 1 to 5 amps depending on the ranging distance required and the sensitivity range for the magnetic sensor deployed in the drill string. For example, it may be required to reduce the electrical current as the distance decreases so as to prevent saturation of the magnetic field sensor. It will be appreciated that the invention is in no way limited by these exemplary model assumptions. It will be also be appreciated that the terms magnetic flux density and magnetic field strength are used interchangeably herein with the understanding that they are substantially proportional to one another and that the measurement of either may be converted to the other by known mathematical calculations.

As shown on FIG. 5A, the magnetic pattern about the electromagnetic array 100′ is similar to that of a magnetic dipole with magnetic flux lines (the dotted lines) extending from one end of the array through a portion of the formation to the other end of the array. The flux density decreases with increasing distance from the array forming substantially ovaloid-shaped surfaces of constant flux density (constant field strength) at distances greater than about the length of the array (distances greater than about 25 feet in the depicted example). Moreover, the direction of the magnetic flux at these distances is approximately parallel to the array axis (i.e., parallel with the target well).

As shown on FIG. 5B, the magnetic pattern about the array 100′ differs significantly (e.g., it is less uniform) from that shown on FIG. 5A due to the induced pair of opposing magnetic poles between electromagnets 110A and 110B. Moreover, the magnetic flux lines tend to be directed towards the array 100′, particularly in the axial vicinity of electromagnets 110A and 110B, even at distances greater than the length of the array. In the exemplary embodiment described with respect to FIGS. 5A and 5B, a positive direct current is portrayed as generating a magnetic dipole while a negative direct current is portrayed as generating a magnetic pattern having a single pair of opposing magnetic poles. The invention is not limited in these regards. It will be understood that the polarity of an electric current is defined my mere convention. The invention is not limited by this convention.

Mathematical models, such as those described above with respect to FIGS. 5A and 5B, may be utilized to create maps of the magnetic field about the target well in the vicinity of the electromagnetic array. During a ranging operation, such as the well intercept operation depicted on FIG. 1, magnetic field measurements may be input into the model (e.g., into a look up table or an empirical algorithm based on the model) to determine a distance to the target well. Various ranging methodologies are described in more detail in commonly assigned U.S. Pat. Nos. 7,617,049 and 7,656,161.

Each of the magnetic field vectors measured at 204 and 208 of method 200 (FIG. 5) are related to the distance between the magnetic field sensor and the electromagnetic array (which is related to the distance between the two wells) and the axial position of the magnetic field sensor relative to a longitudinal point on the electromagnetic array. Those of ordinary skill in the art will readily recognize that any vector may be analogously defined by either (i) the magnitudes of first and second in-plane, orthogonal components of the vector or by (ii) a magnitude and a direction (angle) relative to some in-plane reference. Likewise, the magnetic field vectors measured in method 200 (or the computed interference magnetic field vectors) may be defined by either (i) the magnitudes of first and second in-plane, orthogonal components or by (ii) a magnitude and a direction (angle). In the exemplary embodiment described in more detail below, these vectors are defined by a magnitude and a direction. In general an angle of 0 degrees corresponds with a perpendicular component and therefore indicates a direction pointing orthogonally outward from array. An angle of 90 degrees corresponds with a parallel component and therefore indicates a direction pointing parallel to array in the direction of increasing measured depth of the target. The invention is, of course, not limited by such arbitrary conventions. Nor is the invention limited to defining the vectors in terms of magnitude and direction. Those of ordinary skill in the art will readily be able to make use of substantially any vector notation and convention.

The first and second measured magnetic field vectors (or the computed interference magnetic vectors) may be expressed mathematically, for example, as follows:

M₁=fₚ₁(d,l)

φ₁=fₚ₂(d,l)

M₂=fₙ₁(d,l)

φ₂=fₙ₂(d,l) Equation 3

where M₁ and φ₁ define the first magnetic field vector, M₂ and φ₂ define the second magnetic field vector, d represents the distance between the two wells, l represents the relative axial position of the magnetic field sensors along the axis of array, fₚ₁(·) and fₚ₂(·) represent first and second mathematical functions (or empirical correlations) that define M₁ and φ₁ with respect to d and l when the array is energized with a direct current having a positive polarity, fₙ₁(·) and fₙ₂(·) represent first and second mathematical functions (or empirical correlations) that define M₂ and φ₂ with respect to d and l when the array is energized with a direct current having a negative polarity.

The mathematical functions/correlations fₚ₁(·), fₚ₂(·), fₙ₁(·), and fₙ₂(·) may be determined using substantially any suitable techniques. For example, in one exemplary embodiment of this invention, empirical models may be generated by making magnetic field measurements at a two-dimensional matrix (grid) of known orthogonal distances d and normalized axial positions/relative to an electromagnetic energized at a surface location. Known interpolation and extrapolation techniques can then be used to determine the magnetic field vectors at substantially any location relative to array (thereby empirically defining fₚ₁(·), fₚ₂(·), fₙ₁(·), and fₙ₂(·). In another exemplary embodiment of this invention, fₚ₁(·), fₚ₂(·), fₙ₁(·), and fₙ₂(·) may be determined via mathematical models (e.g., finite element models or differential equations models) of induced magnetization when the array is energized with positive and negative direct currents. Exemplary finite element models are depicted on FIGS. 5A and 5B.

Upon measuring the magnetic field vectors (e.g., the magnitude and angle of the vectors), d and l may be determined using substantially any suitable techniques. For example, d and l may be determined graphically from FIGS. 5A and/or 5B using known graphical solution techniques. Alternatively, d and l may be determined mathematically, for example, via mathematically inverting Equation 7 so that:

d=fₚ₃(M₁,φ₁)

l=fₚ₄(M₁,φ₁)

d=fₙ₃(M₂,φ₂)

l=fₙ₄(M₂,φ₂) Equation 4

where d, l, M₁, M₂, φ₁, and φ₂ are as defined above and fₚ₃(·) and fₚ₄(·) represent mathematical functions that define d and l with respect to M₁ and φ₁ when the array is energized with a direct current having a positive polarity, and fₙ₃(·) and fₙ₄(·) represent mathematical functions that define d and l with respect to M₁ and φ₂ when the array is energized with a direct current having a negative polarity. It will be appreciated that substantially any known mathematical inversion techniques, including known analytical and numerical techniques, may be utilized. Equation 4 is typically (although not necessarily) solved for d and l using known numerical techniques, e.g., sequential one-dimensional solvers. The invention is not limited in these regards.

It will be appreciated that method 200 (FIG. 4) advantageously enables at least first and second determinations of d and l using the corresponding first and second magnetic field vectors. These independent measurements are made using distinct magnetic field patterns and therefore tend to reduce noise and improve ranging accuracy. The measured magnetic field vectors may also be combined (e.g., added or subtracted from one another) and used to determine yet another d and l. For example a model of the combined vector may be generated and solved as described above. A combined vector may also be obtained, for example, by utilizing one of the two vector quantities from the first measurement and the other vector quantity from the second measurement (e.g., combining M₁ and φ₂ or M₁ and φ₁).

The first and/or second magnetic field vectors measured at 204 and 208 of method 200 may further be utilized to compute a direction to the electromagnetic array (e.g., with respect to magnetic north or true north). This may be accomplished for example, by transposing the computed interference magnetic field vector to a plan view (i.e., a horizontal view). Those of ordinary skill in the art will readily appreciate that the azimuth angle of the transposed interference magnetic field vector is equivalent to the direction between the electromagnetic array and the magnetic field sensor. As depicted on FIG. 5B, a magnetic field pattern having at least one pair of opposing poles generally has a stronger horizontal component (i.e., a magnetic field component pointing in the direction of the electromagnetic array). The direction is therefore preferably obtained when the electromagnetic array is energized so as to produce at least one pair of opposing magnetic poles.

Method 200 may further include repositioning the magnetic field sensor at one or more other geometric positions relative to the electromagnetic array (e.g., by continuing to drill the measuring well) and then repeating steps 202 through 210 so as to make additional ranging measurements. These multiple ranging measurements may be used to guide drilling of the measuring well towards the target well (or in a particular direction with respect to the target well).

A plurality of magnetic field measurements made at a corresponding plurality of relative positions (as described in the preceding paragraph) also enables the relative position between the two wells to be determined using other methods. For example, the acquisition of multiple magnetic field measurements enables conventional two-dimensional and three-dimensional triangulation techniques to be utilized. Commonly assigned U.S. Pat. No. 6,985,814 discloses a triangulation technique utilized in passive ranging operations.

The relative positions of the two wells may also be determined from changes in the measured (or interference) magnetic vectors (e.g., the magnitude and/or direction) between any two or more axially spaced measurements. First and second magnetic field measurements may be acquired either simultaneously at first and second longitudinally spaced magnetic field sensors (e.g., spaced at a known distance along the drill string) or sequentially during drilling of the twin well. The invention is not limited in this regard. Use of three or more measurements having known spacing may be advantageously utilized to reduce measurement noise and thereby increase the accuracy of the distance determination. Multiple measurements may also enable other parameters of interest to be determined (e.g., an approach angle of the measuring well relative to the target well).

FIG. 6 depicts a flow chart of another method embodiment in accordance with the present invention in which the relative position of the measured well with respect to the target well may also be determined in substantially real time during drilling (i.e., without stoppage). The electromagnetic array (e.g., array 100 or 100′) is deployed in a first wellbore and energized with a positive direct current at 222. A first axial component of a magnetic field vector (e.g., M_{z} or M_{TZ}) is measured in a second wellbore while drilling at 224 using a magnetic field sensor deployed in the drill string. The electromagnetic array is then energized with a negative direct current at 226. A second axial component of a magnetic field vector is then measured while drilling at 228. The first and second axial components (measured in 224 and 228) are then processed at 230 to compute a distance between the first and second subterranean boreholes. While not depicted in the flow chart, this process is preferably repeated numerous during the drilling operation of the second borehole. Those of skill in the art will readily appreciate that the relative position between the two wells is substantially unchanged between 224 and 228 since these measurements may be made in rapid succession (e.g., within a few seconds of one another).

Mathematical models, such as those described above with respect to FIGS. 5A and 5B, may be utilized to create maps of the magnetic field about the target well in the vicinity of the electromagnetic array. Such maps include at least the axial component of the magnetic field as a function of radial distance from the array and axial position along the length of the array. The radial distance and axial position can often be uniquely determined via an iterative solution. For example, a locus of possible distances and axial positions (i.e., a locus of possible points in the two dimensional map) may be obtained from the first axial component measured at 224 using a first map. A single distance and axial position may then be selected using second axial component measured at 228 and the second map.

While the relative distance and axial position may be determined from a single pair of dynamic axial magnetic field measurements (as described above with respect to FIG. 6), the use of multiple pairs are preferred. In this way, changes in the magnitudes of the axial components as a function of the changing position of the magnetic field sensor may be utilized to locate the measuring well. Commonly assigned U.S. Pat. No. 7,617,049 describes one method by which substantially real-time measurements of the axial component may be utilized to determine a distance between a twin and a target well.

Although the present invention and its advantages have been described in detail, it should be understood that various changes, substitutions and alternations can be made herein without departing from the spirit and scope of the invention as defined by the appended claims.

We claim:

1. An electromagnetic array configured for use in a subterranean borehole, the array comprising:
a substantially cylindrical non-magnetic housing configured to be deployed in a subterranean borehole;
at least first and second electromagnets deployed in the housing, the electromagnets being axially spaced apart and substantially co-axial with one another; and
an electrical module configured to provide an electrical current having a fixed polarity to at least the first electromagnet, the electrical module being electrically connected with at least the first electromagnet and being configured for connecting to an electrical current source.

2. The electromagnetic array of claim 1, wherein the electrical module comprises a diode bridge.

3. The electromagnetic array of claim 1, comprising first, second, and third electromagnets.

4. The electromagnetic array of claim 1, being configured to generate a magnetic field pattern having (i) a single magnetic dipole when energized with an electrical current having a first polarity and (ii) at least one pair of opposing magnetic poles when energized with an electrical current having a second opposite polarity.

5. The electromagnetic array of claim 1, wherein the non-magnetic housing comprises at least one centralizer configured to center the housing in a subterranean borehole.

6. The electromagnetic array of claim 1, wherein each of the electromagnets includes a magnetically permeable core having a length in a range from about 4 to about 16 feet, the core being wound with about 2000 to about 16000 wraps of electrical conductor.

7. The electromagnetic array of claim 1, wherein the first and second electromagnets are electrically connected in series.

8. An electromagnetic array configured for use in a subterranean borehole, the array comprising:
a substantially cylindrical non-magnetic housing configured to be deployed in a subterranean borehole; and
at least first and second electromagnets deployed in the housing, the electromagnets being axially spaced apart and substantially co-axial with one another;
wherein the array is configured to generate a first magnetic field pattern when energized with an electrical current having a first polarity and a distinct second magnetic field pattern when energized with an electrical current having a second opposite polarity, the first magnetic field pattern including a single magnetic dipole and the second magnetic field pattern including at least one pair of opposing magnetic poles.

9. The electromagnetic array of claim 8, further comprising a diode bridge electrically connected with at least the first electromagnet, the diode bridge configured to provide an electrical current having a fixed polarity to at least the first electromagnet.

10. The electromagnetic array of claim 8, comprising first, second, and third electromagnets.

11. The electromagnetic array of claim 8, wherein the non-magnetic housing comprises at least one centralizer configured to center the housing in a subterranean borehole.

12. The electromagnetic array of claim 8, wherein each of the electromagnets includes a magnetically permeable core having a length in a range from about 4 to about 16 feet, the core being wound with about 2000 to about 16000 wraps of electrical conductor.

13. A wireline tool assembly configured for use in a subterranean borehole, the assembly comprising:
a substantially cylindrical non-magnetic housing configured to be deployed in a subterranean borehole;
at least first and second electromagnets deployed in the housing, the electromagnets being axially spaced apart and substantially co-axial with one another;
a length of mono-core cable configured to provide an electrical connection between a power source at a surface location and the electromagnets; and
an electrical module electrically connected between the length of mono-core cable and at least the first electromagnet, the electrical module configured to provide an electrical current having a fixed polarity to at least the first electromagnet irrespective a source polarity provided by the power source.

14. The electromagnetic array of claim 13, wherein the electrical module comprises a diode bridge.

15. The electromagnetic array of claim 13, being configured to generate a magnetic field pattern having (i) a single magnetic dipole when energized with an electrical current having a first polarity and (ii) at least one pair of opposing magnetic poles when energized with an electrical current having a second opposite polarity.

16. The electromagnetic array of claim 13, wherein each of the electromagnets includes a magnetically permeable core having a length in a range from about 4 to about 16 feet, the core being wound with about 2000 to about 16000 wraps of electrical conductor.

17. The electromagnetic array of claim 13, wherein the first and second electromagnets are electrically connected in series.

18. A method for surveying a borehole with respect to a target well; the method comprising:
(a) deploying an electromagnetic array in the target well, the electromagnetic array including a plurality of axially spaced apart electromagnets, the electromagnetic array being configured to generate a magnetic field having (i) a first pattern when energized with an electrical current having a first polarity and (ii) a second pattern when energized with an electrical current having a second opposite polarity;
(b) energizing the electromagnetic array with an electrical current having the first polarity so as to generate a magnetic field having the first pattern about the target well;
(c) causing a magnetic field sensor deployed in the borehole to measure a first magnetic field vector;
(d) energizing the electromagnetic array with an electrical current having the second polarity so as to generate a magnetic field having the second pattern about the target well;
(e) causing the magnetic field sensor to measure a second magnetic field vector; and
(f) processing the first and second magnetic field vectors measured in (c) and (e) to acquire at least a distance between the magnetic field sensor and the electromagnetic array.

19. The method of claim 18, wherein the first pattern comprises a single magnetic dipole and the second pattern comprises at least one pair of opposing magnetic poles.

20. The method of claim 18, wherein (f) further comprises processing the first and second magnetic field vectors in combination with corresponding first and second mathematical models relating the magnetic field vectors to at least the distance between the magnetic field sensor and the electromagnetic array.

21. A method for surveying a borehole with respect to a target well in substantially real time while drilling the borehole, the method comprising:
(a) deploying an electromagnetic array in the target well, the electromagnetic array including a plurality of axially spaced apart electromagnets, the electromagnetic array being configured to generate a magnetic field having (i) a first pattern when energized with an electrical current having a first polarity and (ii) a second pattern when energized with an electrical current having a second polarity;
(b) energizing the electromagnetic array with an electrical current having the first polarity so as to generate a magnetic field having the first pattern about the target well;
(c) causing a magnetic field sensor deployed in the borehole to measure an axial component of a first magnetic field vector while drilling the borehole;
(d) energizing the electromagnetic array with an electrical current having the second polarity so as to generate a magnetic field having the second pattern about the target well;
(e) causing the magnetic field sensor to measure an axial component of a second magnetic field vector while drilling; and
(f) processing the axial components of the first and second magnetic field vectors measured in (c) and (e) to acquire at least a distance between the magnetic field sensor and the electromagnetic array in substantially real time while drilling.

22. The method of claim 21, wherein the first pattern comprises a single magnetic dipole and the second pattern comprises at least one pair of opposing magnetic poles.

23. The method of claim 21, wherein (f) further comprises processing the first and second magnetic field vectors in combination with corresponding first and second mathematical models relating the magnetic field vectors to at least the distance between the magnetic field sensor and the electromagnetic array.
